(19) United States
(12) Patent Application Publication
(10) Pub. No.: US 2004/0091601 A1
(43) Pub. Date: May 13, 2004

(54) Liquid yeast compositions

(76) Inventors: Marie Diane Parnell, Bramhall (GB); Ronald Michael Chell, Manchester (GB); Jean-Marie Huot-Marchand, Paris (FR); Jan Dirk Rene Hille, BN Wouw (NL)

Correspondence Address: Kate H Murashige, Morrison & Foerster, Suite 500, 3811 Valley Centre Drive, San Diego, CA, 92130-2332, US

(21) Appl. No.: 10/451,570

(22) PCT Filed: Dec. 5, 2001
(86) PCT No.: PCT/EP01/14477

(30) Foreign Application Priority Data
Dec. 20, 2000 (EP) 00204668.8

(51) Int. Cl. A23J 1/00

(52) U.S. Cl. 426/656

(57) ABSTRACT

The present invention relates to a composition comprising one or more dough and/or baked product improving processing aids, water and yeast characterised in that the yeast dry matter content of the composition is up to (25)% (w/v).

The present invention relates to a liquid yeast composition and to methods for preparing a dough and baked products thereof using the yeast composition.

Baked products are prepared from a dough which is usually made from the basic ingredients flour, water and optionally salt. Depending on the baked products, other optional ingredients are sugars, flavours etceteras. For leavened products, primarily baker's yeast is used next to chemical leavening systems such as a combination of an acid (generating compound) and bicarbonate. In order to improve the handling properties of the dough and/or the final properties of the baked products, processing aids are employed. Processing aids are therefore defined herein as compounds that improve the handling properties of the dough and/or the final properties of the baked products. Dough properties that may be improved comprise machineability, gas retaining capability, etcetera. Properties of the baked products that may be improved comprise loaf volume, crust crispiness, crumb texture and softness and shelf life. These dough and/or baked product improving processing aids can be divided into two groups: chemical additives and enzymes. Chemical additives with improving properties comprise oxidising agents, reducing agents, and emulsifiers acting as dough conditioners or acting as crumb softeners, fatty materials and others. Presently, there is a trend to replace the chemical additives by enzymes. The latter are considered to be more natural compounds, and therefore more accepted by the consumer. Suitable enzymes may be selected from the group consisting of starch degrading enzymes, arabinoxylan and other hemicellulose degrading enzymes, cellulose degrading enzymes, oxidizing enzymes, fatty material splitting enzymes and protein degrading enzymes.

Yeast, enzymes and chemical additives are generally added separately to the dough. Yeast may be added as a liquid suspension, in a compressed form or as active dry or instant dry yeast. The difference between these yeast formulations is the water- and yeast dry matter content. Liquid yeast has a yeast dry matter content of less than 25% (w/v). Cream yeast is a particular form of liquid yeast and has a dry matter content between 17 and 23% (w/v). Compressed yeast has a dry matter content between 25-35% (w/v) while dry yeast formulations have a dry matter content between 92-98% (w/v).

Enzymes may be added in a dry, e.g. granulated form or in dissolved form. The chemical additives are in most cases added in powder form. Also, processing aid compositions which are tailored to specific baking applications, may be composed of a dedicated mixture of chemical additives and enzymes.

In the baking industry, there is a need to reduce the number of separate handlings such as dosing the various ingredients and processing aids, especially in those industries that want to employ automatic dosing systems. Hereto, certain compositions comprising yeast and processing aids have been developed. EP-A-0619947 discloses homogenous compositions comprising yeast and processing aids whereby the composition contains either compressed yeast or dry yeast.

A recent trend in the baking industry is to use, instead of dry of compressed yeast, liquid yeast such as cream yeast. The liquid formulation allows easier and more accurate dosing, easier cleaning of the dosing equipment and, very importantly, better and more homogeneous mixing with the basic ingredients (flour and water) which results in a more efficient use of the yeast. Problems that were encountered with these liquid yeast suspensions were sedimentation of the yeast cells that lead to an inhomogeneous yeast stock (phase separation). Solutions for the stabilisation of the yeast suspension were obtained either by constant stirring of the suspension, or, by using stabilising substances such as xanthan gum (EP-A-0461725) or modified starch (EP-A-0792930). These stabilising substances do not have a dough and/or baked product improving effect and therefore they do not fall under the definition of processing aid (supra vide).

The disadvantage of the current liquid yeast products is that they require separate dosing of the processing aids. This prohibits the baker to benefit optimally from the advantages of the liquid yeast products.

It is known in the art that many of processing aids commonly used in the baking industry are not sufficiently stable in aqueous solution (e.g. Meucci, E. et al. (1985) Acta Vitaminol. Enzymol. 7 (3-4), 147-154; Souppe, J. in Leatherhead Food RA Ingredients Handbook (1999), ed. R. Rastall, Leatherhead Food RA, Leatherhead, Surrey, U.K. page 48). Since it is also known in the art that this stability is related to factors like time, pH, temperature and the presence of other substances, these processing aids can be protected either by using short transport and storage times and/or handling the processing aids at low temperatures wherever possible and/or by adding stabilizing substances to their formulations. Dilute aqueous solutions of enzymes like fungal alpha-amylase or hemicellulase can be rather instable and may—depending on the conditions—loose their activity during a few days of storage, even at 4° C. Due to their insufficient stability, it is also the present view that it is impossible to make stable compositions that comprise liquid yeast and processing aids, unless the economically unattractive precautions described above, are taken.

The present invention provides compositions comprising one or more dough and/or baked product improving processing aids, as defined above, water and yeast characterised in that the yeast dry matter content of the composition is up to 25% (w/v). It was surprisingly found that said processing aids as well as the yeast were sufficiently stable in these compositions. The compositions of the invention can advantageously be used in the baking industry since they significantly reduce the number of separate handlings (e.g. dosing) in the preparation of baked products. The advantages of the known liquid yeast composition (i.e. without the processing aids) are equally applicable to the compositions of the present invention: easier and more accurate dosing, easier cleaning of the dosing equipment and, very importantly, better and more homogeneous mixing with the basic ingredients (flour and water) and therefore more efficient use of the yeast and, in particular for the compositions of the invention, of the processing aids.

The processing aids are added to the compositions of the invention in such an amount that the properties of the dough and/or of the baked product thereof, are improved when said compositions are added to the dough. As described hereinbefore, the dough and/or baked product improving processing aids can be divided into chemical additives and enzymes. Suitable chemical additives are oxidising agents such as ascorbic acid, bromate and azodicarbonamide and/or reducing agents such as L-cysteine and glutathione. A preferred oxidising agent is ascorbic acid which is added to the composition in such amounts that result in an amount between 5 and 300 mg per kg flour. Surprisingly it was found that the stability of the yeast in the compositions, measured in terms of its gassing power, was improved in the presence of ascorbic acid. Other suitable chemical additives are emulsifiers acting as dough conditioners such as diacetyl tartaric esters of mono/diglycerides (DATEM), sodium stearoyl lactylate (SSL) or calcium stearoyl lactylate (CSL), or acting as crumb softeners such as glycerol monostearate (GMS) or bile salts, fatty materials such as triglycerides (fat) or lecithin and others. Preferred emulsifiers are DATEM, SSL, CSL or GMS. Preferred bile salts are cholates, deoxycholates and taurodeoxycholates.

Suitable enzymes are starch degrading enzymes, arabinoxylan- and other hemicellulose degrading enzymes, cellulose degrading enzymes, oxidizing enzymes, fatty material splitting enzymes, protein degrading enzymes. Preferred starch degrading enzymes are endo-acting amylases such as alpha-amylase and exo-acting amylases such as beta-amylase and glucoamylase. Preferred arabinoxylan degrading enzymes are pentosanases, hemicellulases, xylanases and/or arabinofuranosidases, in particular xylanases from Aspergillus of Bacillus species. Preferred cellulose degrading enzymes are cellulases (i.e. endo-1,4-beta-glucanases) and cellobiohydrolasesi in particular from Aspergillus, Trichoderma or Humicola species. Preferred oxidizing enzymes are lipoxygenases, glucose oxidases, sulfhydryl oxidases, hexose oxidases, pyranose oxidases and laccases. Preferred fatty material splitting enzymes are lipases, in particular fungal lipases from Aspergillus or Humicola species, and phospholipases such as phospholipase A1 and/or A2. Preferred protein degrading enzymes are endo-acting proteinases such as those belonging to the classes thiolproteases, metalloproteases, serine proteases and aspartyl proteases, as well as exo-acting proteinases, also referred to as peptidases, belonging to the class of aminopeptidases and carboxypeptidases.

The enzymes may originate from animal, plant or microbial origin and they may be obtained from these sources by classical processes known in the art, or, alternatively, they may be produced via recDNA technology. A preferred production process comprises fermentation processes in which fungi, yeast or bacteria are grown and produce the desired enzymes, either inherently or as a result of genetic modification (recDNA technology). These processes are well known in the art. Preferably, the enzymes are secreted by the micro-organisms into the fermentation broth. At the end of the fermentation process, the cell biomass is usually separated and, depending on the enzyme concentration in the broth, the latter may be concentrated further and optionally washed by known techniques such as ultrafiltration. Optionally, the enzyme concentrates or a mixture of such concentrates may be dried by known techniques such as spray drying.

Preferred embodiments of the invention are compositions comprising yeast, ascorbic acid and alpha-amylase, preferably fungal alpha-amylase, more preferably alpha-amylase from Aspergillus niger or Aspergillus oryzae. More preferred embodiments are compositions further comprising hemicellulase or xylanase, preferably fungal hemicellulase or xylanase, more preferably hemicellulase from Aspergillus niger or a bacterial xylanase, more preferably xylanase from Bacillus species, in particular Bacillus subtilis. Alpha-amylase is added to the composition in amounts which result in an amount between 5 and 1000 FAU/kg flour. Hemicellulase or xylanase is added to the composition in amounts which result in an amount between 4 and 10000 HU/kg flour.

The compositions of the invention comprise yeast in such an amount that the yeast dry matter content of the composition is up to 25%. Preferably the yeast dry matter content is between 10 and 25%, more preferably between 17 and 23% and has a protein content of 40-65% (N*6.25) based on yeast dry weight and more preferably from 40-56% (N*6.25). Preferred yeast is baker's yeast, e.g. belonging to the genus Saccharomyces, more preferably, the yeast is Saccharomyces cerevisiae. The manufacturing of yeast starts with a small sample of a pure culture. This sample is used to inoculate the first of a series of fermentors of successively increasing size. The first few are mildly aerated batch fermentations. In these stages, conditions are such that ethanol will be formed. Only the last two (or sometimes three) stages are performed using full aeration and incremental feeding of molasses. These fed-batch fermentations are usually carried out in fermentors of 100 m³ (and more) net volume. Fermentation time is typically in the range of 1220 hours, in which some 20,000-30,000 kg of fresh yeast is produced. After the feeding of substrates has stopped, aeration is usually continued at a reduced level for half an hour or so to let the yeast cells attain maturity and uniformity. Further processing may include separation from the broth by centrifugation and washing which results in cream yeast (17-23 wt % dry matter content).

The compositions of the invention can be made by mixing a liquid yeast composition with one or more processing aids as defined hereinbefore. Examples of suitable liquid yeast compositions that may be used are: a concentrated yeast fermentation broth as described in EP-A-0821057, cream yeast or a liquid yeast composition obtained by resuspending compressed yeast., or dry yeast to the required dry yeast matter contents.

The processing aids may be added as dry powders (e.g. chemical additives) or granulated particles (e.g. enzymes) or as liquids such as the enzymes obtained from the fermentation process or solutions obtained after dissolving the dry powders and/or granulates.

In another embodiment, the compositions of the invention further comprise a stabilising agent such as gum that prevents phase separation, i.e. sedimentation of the yeast cells thus avoiding the necessity of stirring the yeast suspension. A suitable concentration of gum may be between 0.03 and 1.0 wt % gum, preferably between 0.05 and 0.25 wt % gum, more preferably between 0.06 and 0.15 wt % and most preferably between 0.07 to 0.10 wt % gum. The gum can be selected from the group consisting of carob, guar, tragacanth, arabic or xanthan gum. Most preferred is xanthan gum.

In a second aspect, the invention provides a method for producing dough characterised by adding a liquid yeast composition as described in the first aspect of the invention.

In a third aspect, the invention provides dough prepared by the method described in the second aspect of the invention.

In a fourth aspect, the invention provides a method for producing a baked product from a dough characterised in that the dough is prepared by the method described in the third aspect of the invention.

In a fifth aspect, the invention provides baked products prepared by the method described in the fourth aspect of the invention.

The present invention will be further demonstrated by the following examples. It should be noted that the present invention is by no means limited to these examples.

### EXAMPLES

In the examples, the following materials and methods were used:

Fungal hemicellulase activity was determined by measuring the amount of reducing sugars produced over a predetermined time period in the micro-assay as described by Leathers, T. D., Kurtzmann, C. P., Detroy, R. W. (1984) Biotechnol. Bioeng. Symp. 14, 225. In this paper the hemicellulase unit (HU) is also defined.

Fungal α-amylase activity is measured as FAU (fungal amylase unit). 1 FAU is defined as the amount of enzyme that converts 1 gram of soluble starch per hour at pH 5.0 and 30° C. into a product having, after reaction with iodine, an equal absorption at 620 nm as a reference solution of CoCl₂ solution in potassium bichromate.

Ascorbic acid was analyzed according to the method of Boehringer (Boehringer Mannheim Biochemical Catalogue (1998) Nr. 409677.

Fermizyme® P₈₀ L is a liquid formulation of a fungal alpha amylase and has an activity of 1900 FAU per gram product.

Fermizyme® P₂₀₀ is a granulated formulation of a fungal alpha amylase and has an activity of 4750 FAU per gram product.

Fermizyme® HS₄₀₀₀ L is a liquid formulation of a fungal hemicellulase and has an activity of 54000 HU per gram product.

Fermizyme® HS₁₀₀₀ is a granulated formation of a fungal hemicellulase and has an activity of 13500 HU per gram product.

All Fermizyme® products are from DSM, Bakery Ingredients, Delft, The Netherlands.

### Example 1

Various blends were prepared according to the recipes shown in Table 1. Cream yeast was stabilized with 0.08% xanthan as described in EP-A-0461725 by addition of a 1% solution of xanthan gum in water. After stabilization, cream yeast pH was set at 5.0.

TABLE 1

| | | | | | Fermi- | |
|---|---|---|---|---|---|---|
| | | | | | zyme | Fermizyme |
| | | | | | P₈₀ L * | HS₄₀₀ L * |
| | Cream | 1% | | Ascorbic | (amy- | (hemi- |
| | yeast | Xanthan | Water | acid | lase) | cellulase) |
| | (g) | (g) | (g) | (mg) | (ml) | (ml) |
| Control | 1250 | 100 | 0 | none | none | none |
| Blend 1 | 750 | 60 | 0 | none | 1.2 | 0.675 |
| Blend 2 | 750 | 60 | 0 | 1250 | 1.2 | 0.675 |
| Blend 3 | 0 | 60 | 750 | 1250 | 1.2 | 0.675 |
| Blend 4 | 0 | none | 500 | None | 0.8 | 0.450 |

| | | |
|---|---|---|
| Activity present in blends: | 3.0 | 45 HU/g |
| | FAU/g | |

Control and blends were stored at 4° C. for 4 weeks. At distinct moments samples were taken for analysis of pH, enzyme activities and for baking batards. French type of batard bread was produced by mixing 3000 g wheat flour, (in total) 1680 g water, 52.5 g salt and the quantities of other dough constituents as given Table 2 in a spiral mixer for 2 min. in speed 1 and 7 min. in speed 2.

TABLE 2

| | | Stabilized | Ascorbic | Fermizyme | Fermizyme |
|---|---|---|---|---|---|
| Dough | Blend | cream | acid | P₈₀L | HS₄₀₀₀L |
| recipe | (g) | (g) | (mg) | (ml) | (ml) |
| Control | none | 97.2 | 150 | 0.145 | 0.082 |
| Blend 1 | 97.6 | None | 150 | None | none |
| Blend 2 | 97.6 | None | none | None | none |
| Blend 3 | 97.6 | 97.2 | none | none | none |
| Blend 4 | 97.6 | 97.2 | 150 | none | none |

Dough temperature after mixing was 27° C. After a bulk proof of 15 min. at 32° C. and 90% RH 6 pieces of 350 g dough were weighed and rounded. An intermediate proof of 15 min. at 32° C. and 90% RH was applied after which the dough's were punched and moulded. After a final proof of 75 min. at 32° C. and 90% RH the dough's were baked at 240° C. for 25 min. in an electric oven. After cooling down to room temperature of loaf volumes were obtained in triplicate by use of the rapeseed displacement method. In Table 3 the results of analyses and baking are gathered.

TABLE 3

| | | | Fungal | Fungal | Loaf |
|---|---|---|---|---|---|
| | | | alpha- | hemi- | volume |
| Storage time of | Gassing power | | amylase | cellulase | Batards |
| blends (days) | ml (%) | pH | (FAU/g) | (HU/g) | (ml) |
| Control | | | | | |
| 2 | 333 (100) | 5.2 | n.d * | n.d | 1426 |
| 8 | 318 (95) | 5.3 | n.d | n.d | 1370 |
| 15 | 312 (94) | 5.3 | n.d | n.d | 1506 |
| 29 | 303 (91) | 5.4 | n.d | n.d | 1350 |
| Blend 1 | | | | | |
| 2 | 308 (100) | 4.7 | 3.1 | 50 | 1363 |
| 8 | 308 (100) | 5.2 | 4.0 | 58 | 1387 |
| 15 | 299 (97) | 5.1 | 3.1 | 69 | 1376 |
| 29 | 294 (95) | 5.0 | 3.0 | 69 | 1353 |
| Blend 2 | | | | | |
| 2 | 309 (100) | 4.9 | 5.2 | 63 | 1422 |
| 8 | 311 (101) | 5.2 | 6.0 | 62 | 1433 |
| 15 | 299 (97) | 5.1 | 3.6 | 57 | 1440 |
| 29 | 295 (95) | 5.3 | 3.4 | 65 | 1343 |
| Blend 3 | | | | | |
| 2 | — | 4.6 | n.d | 30 | 1419 |
| 8 | — | 4.6 | 3.0 | 86 | 1420 |
| 15 | — | 4.6 | n.d | 32 | 1415 |
| 29 | — | 4.6 | n.d | 31 | 1251 |
| Blend 4 | | | | | |
| 2 | — | 4.7 | n.d | n.d | — |
| 8 | — | 4.8 | n.d | n.d | — |
| 15 | — | 4.8 | n.d | n.d | 1146 |
| 29 | — | 4.7 | n.d | n.d | 1219 |

* n.d = not detectable

The gassing power of yeast was not influenced by the other processing aids introduced in the blends. Control and blends pH went all up to values above 5 during storage.

Alpha-amylase and fungal hemicellulase were found to be very unstable in aqueous solution (blend 4) since no activity could be detected after storage for 1 day.

Alpha-amylase was stabilised by yeast (compare blend 1 versus blend 4) but not by ascorbic acid (compare blend 3 with 4). Blend 2 showed an alpha-amylase activity which was higher than calculated to be present (3.0 FAU per gram—Table 3 which was found to be caused by the presence of ascorbic acid interfering with FAU-analysis method. In blends 3 and 4 this effect was not seen.

Fungal hemicellulase was stabilised by both yeast (compare blend 1 with blend 4 and ascorbic acid (compare blend 3 with blend 4).

### Example 2

Cream yeast (996.64 g) and ascorbic acid (3.36 g) were mixed and kept stirring in a water bath at 4° C. for 7 days (blend 5). Cream yeast (1000 g) without ascorbic acid served as a reference.

At day 2, 4 and 7, toast bread was baked using of the two cream yeasts. In a Morton mixer 1000 g wheat flour, 580 g water, 20 g salt, 33 mg Fermizyme P₈₀L, 10 mg Fermizyme HS₄₀₀₀L, 2.1 g Panodan AB 100 VEG-FS (Datem produced by Danisco Cultor, Denmark) and the other dough constituents depicted in Table 4.

TABLE 4

| | | Reference cream | Ascorbic |
|---|---|---|---|
| | Blend (g) | yeast (g) | acid (g) |
| Control | none | 29.7 | 0.10 |
| Blend 5 | 29.8 | none | none |

Mixing time was 2.5 min., dough temperature was 30° C. Doughs were scaled to 460 g pieces, moulded, given a short proof of 5 min. at 32° C. and 80% RH, again moulded, shaped and panned and given a final proof time of around 60 min. to a final dough height of 11.5 cm at 40° C. and 80% RH. Afterwards the doughs were baked for 22 min. at 225° C. Directly after baking the height of the loaves was determined. The next morning the loaves were assessed for crumb colour, internal texture, and crumb softness. Results are shown in Table 5.

TABLE 5

| | | | | | |
|---|---|---|---|---|---|
| | Ascorbic | | | | |
| | acid | | Bread | | |
| | (mg/g | Proof time | height | Crumb | Crumb |
| pH | cream) | (min.) | (cm) | colour * | texture * |

| Day | 1 | 7 | 1 | 7 | 2 | 7 | 2 | 7 | 2 | 7 | 2 | 7 |
|---|---|---|---|---|---|---|---|---|---|---|---|---|
| Control | 5.8 | 5.5 | — | — | 65 | 74 | 15.2 | 14.7 | 120 | 120 | 120 | 120 |
| Blend 5 | 4.8 | 4.8 | 3.44 | 3.36 | 60 | 71 | 15.0 | 15.6 | 124 | 154 | 122 | 148 |

* The crumb of 6 halves of bread was judged independently by 2 persons. Control quality is fixed at level 10. Quality improvement leads to level > 10, less quality to level < 10.

The pH of blend 5 was much lower than that of control which was caused by the presence of ascorbic acid. The oxidizing agent remained at a constant level in the cream liquid. Baking tests at day 2 showed similar results in bread height but were reached by the blend in a somewhat shorter proofing time. The other bread characteristics were comparable. Baking tests after 7 days of storage showed a significant better result for the blend because in a shorter proofing time much larger bread was produced. Also crumb colour and texture were clearly better than found for the control.

From these results it is clear that the stability of the yeast in this blend was improved by the presence of ascorbic acid. The gas retaining capacity of the dough should be equivalent for blend and control because ascorbic acid in the blend is at the original level. Most probably the yeast stability in terms of gassing power was improved.

### Example 3

Cream yeast was stabilized with. 0.08% xanthan as described in EP-A-0461725. Afterwards, the following quantities of ascorbic acid (as dry powder) and/or enzymes (as granulated product) were added to 1000 g of stabilized yeast cream and mixed by mechanical stirring (see Table 6).

TABLE 6

| | | | Fermizyme ® | |
|---|---|---|---|---|
| | Stabilized | Ascorbic | HS1000 | P200 |
| | cream yeast | acid | (hemicellulase) | (α-amylase) |
| | (g) | (g) | (g) | (g) |
| Control | 1000 | none | none | none |
| Blend 6 | 1000 | none | 1.2 | 0.15 |
| Blend 7 | 1000 | 0.7 | 1.2 | 0.19 |

After their preparation, the control and blends were stored at 4° C. for 29 days. At regular time intervals, the pH of the composition as well as their hemicellulase and alpha-amylase activity activities were analyzed according to the methods described in Example 1.

The gas producing capacity of the yeast and the gas holding capacity of the dough was measured by baking French type batards of the dough's prepared by adding to 2000 g wheat flour, 1140 g water, 45 g NaCl, and the following amounts of ascorbic acid and enzymes (based on flour—see Table 7).

TABLE 7

| | | | Fermizyme ® | |
|---|---|---|---|---|
| | | Ascorbic | HS1000 | P200 |
| | Composition | acid | (hemicellulase) | (α-amylase) |
| | (g) | (mg) | (mg) | (mg) |
| Control | 100 | 70 | 120 | 15 |
| Blend 6 | 100 | 70 | none | none |
| Blend 7 | 100 | none | none | none |

All ingredients were mixed in a spiral mixer for 3 min. in 1^{st} speed and 13 min. in the 2^{nd} speed. The dough temperature after mixing was 24° C. The machineability of the dough was analyzed by hand. The dough was given a bulk proof of 30 min. ambient temperature. Afterwards the dough was divided into 350 g pieces which were moulded and given a final proof of 120 min. at 25° C. and 85% RH. The dough's were baked in an electric oven at 250° C. for 25 min. After cooling down to room temperature the volume of the loaves was determined by using the rapeseed displacement method.

TABLE 8

| Storage time | | AA * | Hemicellulase | Alpha-amylase | Loaf |
|---|---|---|---|---|---|
| Of blends | | g/1000 g | (HU/1000 | (FAU/1000 g | volume |
| (days) | pH | blend) | g blend) | blend) | (mL) |
| Control | | | | | |
| 0 | — | n.d. * | n.d. | n.d. | 2090 |
| 7 | 5.4 | n.d. | n.d. | n.d. | 2210 |
| 14 | 5.7 | n.d. | n.d. | n.d. | 1930 |
| 21 | 5.5 | n.d. | n.d. | n.d. | 1970 |
| 28 | 5.5 | n.d. | n.d. | n.d. | 2150 |
| Blend 6 | | | | | |
| 0 | — | n.d. | 18765 | 700 | 2100 |
| 7 | 5.5 | n.d. | 17145 | 680 | 2210 |
| 14 | 5.7 | n.d. | 13500 | 800 | 1890 |
| 21 | 5.4 | n.d. | 14985 | 820 | 2130 |
| 28 | 5.4 | n.d. | 16065 | 700 | 2150 |
| Blend 7 | | | | | |
| 0 | — | 0.64 | 15120 | 900 | 2000 |
| 7 | 5.3 | 0.69 | 17415 | 900 | 2050 |
| 14 | 5.5 | 0.65 | 14580 | 1100 | 1920 |
| 21 | 5.3 | 0.65 | 14445 | 870 | 1960 |
| 28 | 5.3 | 0.65 | 14850 | 1000 | 2130 |

* AA = Ascorbic acid;
n.d. = not detectable which means that the results were below the detection limit.

In Table 8 the results of the analyses during the storage period are given as well as the loaf volumes of the breads after baking. The pH of the various compositions did not vary significantly in time, indicating that no lysis of the yeast cells occurred. The ascorbic acid levels in blend 7 remained constant during storage. The activity levels that were measured for hemicellulase and alpha-amylase in blends 6-7 during the storage period, show that both enzymes retained their activity.

The loaf volumes of the breads baked with the blends 6 and 7 and the control show that the yeast retained its gas production capacity and that the dough's retained their gas retaining capacity.

### Example 4

Blends of stabilized cream yeast (including 0.08% xanthan) and Datem emulsifier were prepared, stored and applied in breadmaking.

Datem (either Panodan 80 CP in powder form or Panodan AB 100 VEG-FS in liquid form (both from Danisco Cultor, Denmark)) is easily dispersed in water or cream yeast. These dispersions show to be very acidic (pH<2). This low pH is very detrimental to yeast quality. As described in EP-A-0251020 Datem dispersions can be neutralized with alkaline without destroying all emulsifier activity. This was checked by preparing a dispersion of Datem by weighing 10 g water in a beaker containing a magnetic stirrer, adding slowly 6.0 g Panodan AB, adjusting the pH to 4.75 by addition of 2M NaOH and applying it in production of batard type of bread.

Batard bread was produced by mixing 3000 g wheat flour, (in total 1680 g) water, 52.5 g salt, 300 mg. ascorbic acid, 30 mg Fermizyme® P₂₀₀, 60 mg Fermizyme® HS₂₀₀₀, 3.0% stabilized cream yeast, and either 6 g Panodan AB 100, or the total dispersion of Datem. Dough mixing and processing was done according to the method described in Example 1. After cooling down to room temperature loaf volumes were obtained in triplicate by use of the rapeseed displacement method:

| | |
|---|---|
| Loaf volume obtained after adding 6.0 g of | 1627 ± 30 ml |
| Datem directly to the dough: | |
| Loaf volume obtained after adding the dispersion | 1549 ± 28 ml |
| of Datem as described: | |
| Loaf volume for control without addition of Datem | 1025 ± 25 ml |

From these results it was concluded that the influence of dispersing Datem and adjusting pH previous to addition to the dough mixture is in the order of 7% reduction in loaf volume.

To see the effects of both combining cream yeast and emulsifier and the effect of neutralization on Datem and yeast quality the following options were tested:

A. dispersion of Datem in small quantity of water, neutralization to pH 6.0 by adding 2M NaOH and addition of dispersion to stabilized cream yeast

B. dispersion of Datem in small quantity of cream yeast, neutralization to pH 6.0 by adding 2 M NaOH and addition of dispersion to stabilized cream yeast

C. dispersion of Datem in full quantity of stabilized cream yeast (as is ratio in baking recipe), neutralization to pH 6.0 by adding 2 M NaOH.

Dispersions of Datem in options A and B were prepared by weighing 60 g water or stabilized cream in a beaker containing a magnetic stirrer, adding slowly 33.6 g Datem (powder or liquid), and after adjusting pH the final weight of the blend is brought to 133.6 g by adding either water or stabilized cream.

TABLE 9

| | | | Dosage level in | | Keepability (stored at 4° C.) | | | | |
|---|---|---|---|---|---|---|---|---|---|
| | | Added | dough based on | | | | | | Loaf |
| Dispersion | | to | flour | | pH | | Gas (ml) | | vol. |
| | Datem/ | Yeast | | Total | Cream | | Production** | | (ml) |
| | liquid | cream | Datem | Cream | Day | Day | Day | Day | Day |
| | G/g | (g) | (%) | (%) | 1 | 8 | 1 | 8 | 8 |
| Ref. 1 | | | | 3.0 | 6.0 | 5.3 | 368 | 357 | 488 |
| Ref. 2 p* | | | 0.2 | 3.0 | | | | | 624 |
| A: p* | 33.6/100 | 500 | 0.2 | 3.8 | 6.0 | 5.7 | 290 | 286 | 601 |
| | | | | | | | (367) | (362) | |
| B: p* | 33.6/100 | 400 | 0.2 | 3.2 | 6.0 | 5.5 | 335 | 330 | 600 |
| | | | | | | | (358) | (354) | |
| B: l* | 33.6/100 | 400 | 0.2 | 3.2 | 6.0 | 5.6 | 335 | 329 | 590 |
| | | | | | | | (358) | (353) | |
| C: p* | 33.6/500 | — | 0.2 | 3.2 | 6.0 | 5.4 | 322 | 320 | 578 |
| | | | | | | | (347) | (343) | |
| C: l* | 33.6/100 | — | 0.2 | 3.2 | 6.0 | 5.5 | 329 | 324 | 583 |
| | | | | | | | (355) | (346) | |

*p = use of Panodan 80 CP;
l = use of Panodan AB 100 VEG-FS;
**values between brackets are calculated values for the cream part (corrected for added mass).

Addition of Datem did not influence the physical stability of the stabilized cream during storage. Changes in pH, gassing and baking performance were followed during a storage period of 8 days. Pup loaves were prepared from 150 g dough pieces obtained by mixing 200 g wheat flour, 117 g water, 2% salt, 3 g sugar, 25 ppm ascorbic acid, 25 ppm Fermizyme® P₂₀₀, 67 ppm Fermizyme® HS₂₀₀₀, 6 g stabilized cream yeast (reference 1) and 0.4 g Panodan 80 CP (reference 2) or an equivalent quantity of one of the blends A, B, or C. Dosage levels and baking results are shown in Table 9.

From these results it is clear that no differences in results are seen for both forms of the emulsifier. The pH of the various blends decreased to more or less the same extent as pH of the reference stabilized cream. Addition of neutralized Datem dispersion did not influence yeast gassing power. Neutralization in the yeast cream affected yeast gassing to some extent. Baking resulted in similar loaf volumes for options A and B being somewhat lower (about 5%) than volume of reference 2 (cream yeast and Datem separately added). Most probably this difference was caused by the neutralization of the Datem dispersions. Baking results for option C were somewhat lower most probably caused by the reduced gassing power of the cream.

From these results it is clear that cream yeast and Datem can be combined without loss of physical stability of the stabilized cream and that performance of both yeast and Datem in baking is only influenced to a very limited extent. To check whether this negative influence on volume can be compensated by addition of extra yeast and/or Datem the following blends (see Table 10) were tested directly after production in batard breadmaking as described above. Of both control and blends 3.52% was dosed in baking. In all cases the enzymes and ascorbic acid were added separately to the dough mix. In case of control also 0.20% Datem was added to the dough mix.

From these results shown in Table 10 it is clear that the loss in baking performance can be fully compensated by addition of 5% extra cream yeast to the dough mixture (3.15% instead of 3.0% cream yeast based on flour).

TABLE 10

| | Composition of blend | | | | Loaf |
|---|---|---|---|---|---|
| | Stabilized | | Water | Panodan AB | volume |
| | cream(g) | | (g) | 100 (g) | (ml) |
| Control | 250 | | 42.5 | — | 1619 |
| Blend 8 | 262.5 | (+5%) | 13.4 | 16.6 (0.20%) | 1629 |
| Blend 9 | 262.5 | (+5%) | 12.5 | 17.5 (+5%) | 1663 |
| Blend 10 | 275 | (+10%) | 0.9 | 16.6 | 1633 |

### Example 5

Various blends of stabilized cream yeast (including 0.08% xanthan), Datem, ascorbic acid and enzymes were prepared as depicted in Table 11, stored at 4° C. for 3 weeks and applied in breadmaking.

Blend 11 was prepared by dissolving ascorbic acid in the cream yeast after which the pH was brought to 4.7 by addition of 2M NaOH. This pH is the best for both ascorbic acid and enzyme stability. Subsequently, fungal alpha-amylase and hemicellulase were added as liquid preparations at the levels given in Table 11.

Blend 12 was prepared by mixing 50.1 g Panodan AB 100 with 100 g stabilized cream yeast by use of a magnetic stirrer after which the pH was brought to 4.7 by addition of 2M NaOH. Ascorbic acid was dissolved in the remaining part of the stabilized cream (810−100=710 g) after which the pH was also brought to 4.7. After combining the two parts of cream yeast fungal alpha-amylase and hemicellulase were added as liquid preparations at the levels given in Table 11. Enzyme activities, pH, and baking performance were tested every week during a storage period of 3 weeks.

TABLE 11

| | Stabi- | | | | | Pano- |
|---|---|---|---|---|---|---|
| | lized | | Ascor- | | Hemi- | dan |
| | cream | | bic | Amylase | cellulase | AB |
| | yeast | Water | acid | P₈₀L * | HS₄₀₀₀L | 100 |
| | (g) | (g) | (g) | (g) | (g) | (g) |
| Control | 810 | 75 | — | — | — | — |
| Blend 11 | 810 | 64 | 2.49 | 0.6 | 0.225 | — |
| Blend 12 | 810 | 14 | 2.49 | 0.6 | 0.225 | 50.1 |

Both blends were physically stable during the storage period. Batard type bread was prepared as described in Example 1. For the control, Datem, ascorbic acid and enzymes were added separately to the dough mixture and in case of Blend 11, Datem was added separately. Results obtained with fresh blends (day 1) and blends stored for 3 weeks at 4° C. (day 22) are summarized in Table 12.

TABLE 12

| | Gassing power | | | | Loaf volume |
|---|---|---|---|---|---|
| | (ml) | | Alpha-amylase | Hemicellulase | (ml) |
| | ((%)) | pH | (FAU/g) | (HU/g) | ((%)) |
| | Day 1 → day 22 | | | | |
| Control | 306 → 292 | 5.2 → 5.3 | n.a. | n.a. | 1422 → 1358 |
| | (100 → 95) | | | | (100 → 95) |
| Blend 11 | 298 → 288 | 4.7 → 5.1 | 3.1 → 2.9 | 17.5 → 17.4 | 1420 → 1366 |
| | (97 → 94) | | | | (100 → 96) |
| Blend 12 | 289 → 262 | 4.8 → 5.0 | 3.8 → 3.5 | 12.2 → 13.5 | 1327 → 1242 |
| | (94 → 86) | | | | (93 → 87) |

The blend comprising cream yeast, enzymes and ascorbic acid (blend 11) behaved the same as the control for all the parameters tested (Table 12). Only when Datem was additionally added (blend 12), the initial gassing power and hemicellulase activity were slightly affected. However, neither an extra loss of gassing power nor an extra loss in hemicellulase activity was observed during storage.

Baking results for control and blend 11 were equivalent. Only when Datem was additionally added (blend 12), the loaf volumes were ca 5% lower. These lower volumes were most probably caused by the lower initial gassing power plus a somewhat lower Datem performance.

### Example 6

Various blends were prepared as depicted in Table 13, stored at 4° C. for 29 days, and applied in a frozen dough application. Lecithin was used as emulsifier. Also inactivated dried yeast was included as an important processing aid for relaxing dough for French sticks. Cream yeast was stabilized with 0.08% xanthan. The following quantities of ascorbic acid (as dry powder), enzymes (as granulated product), lecithinated flour (wheat flour containing 20% lecithin), or inactivated dried yeast (TE89) were added to cream and mixed by mechanical stirring (see Table 13).

All blends were physically stable during the storage period. Functionality of the various blends was tested in baking French sticks via frozen dough preparation. Dough's were prepared directly after producing the various blends and after storing the blends for 2 and 4 weeks, respectively.

TABLE 13

| | | | Fermizyme | | | |
|---|---|---|---|---|---|---|
| | | | HS | | Inacti- | |
| | | | 2000 | | vated | |
| | Stabilized | Ascor- | Hemi- | P200 | dried | Lecithin- |
| | Cream | bic | cellu- | Alpha- | yeast | ated |
| | yeast | acid | lase | amylase | TE89 | flour |
| | (g) | (g) | (g) | (g) | (g) | (g) |
| Control | 1000 | — | — | — | — | — |
| Blend 13 | 1000 | 1.0 | 0.8 | 0.042 | — | — |
| Blend 15 | 1000 | 1.0 | 0.8 | 0.042 | 46.7 | — |
| Blend 14 | 1000 | 2.1 | 1.12 | 0.059 | — | 113.4 |

Dough's were prepared by adding to 3500 g wheat flour, 2048 g water, 77 g NaCl and the following amounts of other ingredients (based on flour—see Table 14). The stabilized cream yeast applied was in the controls was of course stored as the corresponding blend. All ingredients were mixed in a spiral mixer for 3 min. in 1^{st} speed and 12 min. in the 2^{nd} speed. The dough temperature after mixing was 20° C. No bulk proof was given to the dough. Afterwards, the dough was divided into 350 g pieces which were subsequently moulded, frozen (−40° C. during 40 minutes) within 30 min. after mixing and stored at −18° C. for 10 and 30 days.

TABLE 14

| | | | | Fermizyme | | | |
|---|---|---|---|---|---|---|---|
| | | | | HS | | | |
| | | Stabi- | | 2000 | | | |
| | | lized | Ascor- | Hemi- | P200 | Lecithin- | |
| | | Cream | bic | Cellu- | Alpha- | ated | |
| | Blend | yeast | acid | lase | amylase | Flour | TE89 |
| | (g) | (g) | (g) | (g) | (g) | (g) | (g) |
| Control | — | 262.5 | 0.2625 | 0.210 | 0.011 | — | — |
| 13 | | | | | | | |
| Blend | 263.0 | — | — | — | — | — | — |
| 13 | | | | | | | |
| Control | — | 262.5 | 0.560 | 0.294 | 0.015 | 29.77 | — |
| 14 | | | | | | | |
| Blend | 293.1 | — | — | — | — | — | — |
| 14 | | | | | | | |
| Control | — | 262.5 | 0.2625 | 0.210 | 0.011 | — | 12.2 |
| 15 | | | | | | | |
| Blend | 275.2 | — | — | — | — | — | — |
| 15 | | | | | | | |

After storage the doughs were defrosted, proofed (30° C. during 1 hour) and baked (250° C. during 25 minutes) in an electric oven at 250° C. for 25 min. After cooling to room temperature the volume of the loaves was determined in triplicate by use of the rapeseed displacement method.

In Table 15 the baking results are summarised. Results given are the ratios of the loaf volumes obtained after introduction of a blend and the loaf volume of the corresponding control.

TABLE 15

| | ratio of loaf volume blend/control (%) | | | | | |
|---|---|---|---|---|---|---|
| Storage time blends | 0 | | 2 | | 4 | |
| (weeks at 4° C.) | | | | | | |
| Storage time frozen | 10 | 30 | 10 | 30 | 10 | 30 |
| dough (days) | | | | | | |
| Blend 13 | 110 | 103 | 106 | 96 | 96 | 97 |
| Blend 14 | n.d. | n.d. | n.d. | n.d. | 104 | 111 |
| Blend 15 | 101 | 99 | 98 | 100 | n.d. | 97 |

*n.d. not determined

From these results it is clear that the blends are performing as well as the controls. This means that both yeast and processing aids are sufficiently stable in these compositions also when applied in frozen dough applications.

1. A composition comprising one or more dough and/or baked product improving processing aids, water and yeast characterised in that the yeast dry matter content of the composition is up to 25% (w/v).

2. A composition according to claim 1 wherein the processing aids are chemical additives and/or enzymes.

3. A composition according to claim 1 or 2 wherein the chemical additives are oxidising agents, reducing agents, emulsifiers and/or bile salts, and the enzymes are starch degrading enzymes, arabinoxylan degrading enzymes, hemicellulose degrading enzymes, cellulose degrading enzymes, oxidizing enzymes, fatty material splitting enzymes and/or protein degrading enzymes.

4. A composition according anyone of claims 2 and 3 wherein one of the chemical additives is ascorbic acid.

5. A composition according to claim 4 wherein ascorbic acid is added in an amount resulting in an amount between 5 and 300 milligram per kg flour.

6. A composition according to anyone of claims 24 wherein the enzymes are alpha-amylase and/or hemicellulase.

7. A composition according to claim 6 wherein alpha-amylase is added in an amount resulting in an amount between 5 and 5000 FAU per kg flour.

8. A composition according to claim 6 wherein hemicellulase is added in an amount resulting in an amount between 4 and 10000 HU per kg flour.

9. A composition according to anyone of the preceding claims, wherein the yeast dry matter content is between 10 and 25% (w/v).

10. A composition according to anyone of the preceding claims, wherein the yeast is baker's yeast.

11. A composition according to anyone of the preceding claims, wherein the yeast is Saccharomyces cerevisiae.

12. A composition according to anyone of the preceding claims further comprising gum.

13. A composition according to claim 12 comprising 0.03 to 1 wt % gum.

14. A composition according to anyone of claims 12 and 13 wherein the gum comprises carob, guar, tragacanth, arabic or xanthane gum.

15. A method for producing a dough according to known methods characterised by adding a composition as defined in anyone of claims 1-14.

16. A dough prepared by the method as defined in claim 15.

17. A method for producing a baked product from a dough according to known methods characterised in that the dough is prepared by the method as defined in claim 15.

18. A baked product prepared by the method as defined in claim 17.

19. Use of a composition as defined in anyone of claims 1-14 for the preparation of a dough and/or a baked product thereof.
